(19) United States
(12) Patent Application Publication
(10) Pub. No.: US 2026/0219870 A1
(43) Pub. Date: Jul. 30, 2026

(54) SYSTEMS AND METHODS FOR DYNAMIC CONTEXT RETRIEVAL, CONTEXTUAL MEMORY, AND AUTONOMOUS SOFTWARE CREATION USING SWARM-BASED ORCHESTRATION AND EPHEMERAL VALIDATION

(71) Applicant: Nirmal Singh Baid, Miami, FL (US)

(72) Inventor: Nirmal Singh Baid, Miami, FL (US)

(21) Appl. No.: 19/458,768

(22) Filed: Jan. 24, 2026

Related U.S. Application Data
(60) Provisional application No. 63/749,218, filed on Jan. 24, 2025.

(51) Int. Cl. G06F 8/65

(52) U.S. Cl. CPC G06F 8/65

(57) ABSTRACT

Systems and methods are disclosed for dynamic context retrieval and autonomous software creation for conversational artificial intelligence. A user query is received, and candidate context items are retrieved using multi-stage filtering over at least one of a vector database and a knowledge graph. The retrieved context is compressed using summarization and keyword extraction and combined with contextual memory that tracks entities, relationships, events, and user-specific context across sessions. A swarm-based architecture of specialized models generates context-aware responses and generates or modifies executable software code. Generated code is deployed into an ephemeral test environment for functional checks, security checks, and domain-specific compliance checks. Real-time updates synchronize newly acquired or updated data and can trigger refetch and regeneration. In some embodiments, the system assembles a bounded context package under a budget constraint, injects machine-interpretable constraints derived from compliance findings, and iterates until a convergence condition is satisfied.

### CROSS-REFERENCE TO RELATED APPLICATIONS

This application claims the benefit of U.S. Provisional Application No. 63/749,218, filed on Jan. 24, 2025, entitled DYNAMIC CONTEXT RETRIEVAL AND AUTONOMOUS SOFTWARE CREATION SYSTEM FOR CONVERSATIONAL AI, the entire contents of which are incorporated herein by reference to the extent permitted by law.

### TECHNICAL FIELD

The present disclosure relates to computer-implemented systems that construct bounded context packages under resource budgets and use artificial intelligence to generate and validate executable software artifacts. More particularly, the disclosure relates to closed-loop architectures that (i) retrieve and compress context under token/size/time/cost constraints, (ii) generate code and related artifacts, (iii) execute tasks via scripts, command-line tools, SDK calls, connectors, and application programming interfaces (APIs), locally and/or in cloud environments, (iv) validate via isolated execution environments and programmatic telemetry, (v) generate machine-interpretable violation packets, (vi) derive and inject regeneration constraints, (vii) update causal memory and retrieval/generation weights, and (viii) converge to compliant and functional artifacts.

### BACKGROUND

Many AI systems operate under fixed context window limits and other resource constraints. Real-world tasks often require referencing a large and evolving corpus of code, documentation, policies, logs, and historical sessions. Inserting all candidate context into a single prompt is often infeasible.

Conventional retrieval may return large candidate sets, and conventional summarization may omit constraints needed for correct generation. Moreover, autonomous software generation systems often fail without a reliable closed loop that executes, validates, and corrects artifacts based on objective signals.

Existing agentic systems frequently split into (i) “computer-use” systems that act through user interfaces and vision, and (ii) tool/API systems that invoke programmatic interfaces. Tool/API systems can be more reliable but require explicit verification (return codes, tests, logs, file diffs, object-model state). A need exists for a unified closed-loop controller that operates under budgets, executes programmatically, validates in isolated environments, produces machine-interpretable violations, derives constraints, updates causal memory, and converges.

Some recently announced agent systems emphasize browser-based automation or user-interface-driven action execution (sometimes referred to as operator-type systems). While such systems may perform certain tasks, they may not provide (i) dynamic context retrieval from both a vector database and a knowledge graph with multi-stage filtering and compression, (ii) persistent contextual memory tracking entities, relationships, events, and user-specific context across sessions, and (iii) closed-loop autonomous software creation that deploys generated code in ephemeral environments with functional, security, and domain-specific compliance checks prior to production use.

### SUMMARY

In some embodiments, a system receives an input query describing a task and constraints. The system retrieves candidate context items from a corpus that may include at least one of a vector database, a knowledge graph, document stores, code repositories, policy stores, and historical session memory. The system compresses and packs the context into a bounded context package under a budget constraint, optionally reserving budget for constraint units, schema extracts, and API signature extracts.

In some embodiments, the system generates an end-to-end application artifact set including at least one of a front-end user interface, one or more back-end services, an API definition, database schema or migration artifacts, authentication configuration, infrastructure-as-code templates, build scripts, test artifacts, and deployment artifacts.

In some embodiments, generating the end-to-end application artifact set comprises invoking at least one large language model (LLM) conditioned on the bounded context package. In some embodiments, the artifact generation module coordinates a swarm-based architecture of specialized models via an orchestration controller to generate, review, test, and modify the executable software artifacts.

In some embodiments, the system executes tasks using programmatic execution, including invoking scripts, CLI tools, SDK calls, connectors, plugins, function calls, and application programming interfaces (APIs) locally and/or in cloud environments, and validates execution using programmatic verification including return codes, logs, test results, telemetry, file diffs, and object-model state.

In some embodiments, the system runs isolated execution environments (containers, micro-virtual machines, sandboxes, emulators, device farms, or other isolated runtimes) to validate generated artifacts. The system collects telemetry, applies compliance rules, outputs machine-interpretable compliance violation packets, derives regeneration constraints, injects those constraints into subsequent context packages or generation prompts, updates causal memory and retrieval/generation weights, and iterates until convergence.

In some embodiments, the system supports real-time updates using WebSockets, server-sent events (SSE), polling, or message-queue subscriptions, and triggers automatic refetch/rerank/repack of context upon new commits, new documents, new telemetry, or updated policies.

In some embodiments, the system generates personalized responses and personalized code modifications based on a user profile, contextual memory, and compressed context units, thereby producing user-specific or domain-specific results.

In some embodiments, context compression includes extractive summarization, abstractive summarization, and keyword extraction. Non-limiting examples include using transformer-based extractive summarization models (for example BERT-based extractive summarizers) and sequence-to-sequence abstractive summarization models (for example T5 or BART).

In some embodiments, the system includes an ephemeral test environment module that launches a containerized sandbox or a virtual-machine-based sandbox to autonomously validate generated code. Validation may include functional tests, security checks, and embedded domain-specific compliance checks for regulations and policies including HIPAA, PCI, and GDPR.

In some embodiments, the system performs prompt-based autonomous execution in which a high-level user prompt is decomposed into requirements including user stories, a data schema, business logic, user interface components, and compliance rules, and the system iteratively generates, tests, and refines an end-to-end artifact set until a convergence condition is satisfied.

An advantage is achieved by uniting dynamic context retrieval, contextual memory, swarm-based orchestration, real-time updates, and ephemeral validation into a closed-loop architecture that can continuously improve outputs and reduce recurrence of prior failures.

### BRIEF DESCRIPTION OF THE DRAWINGS

FIG. 1 is a block diagram of an example closed-loop controller integrating bounded context assembly, programmatic execution, isolated validation, constraint derivation, and causal memory updates.

FIG. 2 is a flow diagram of multi-stage retrieval, compression into units, and packing under a budget with reserved constraint units.

FIG. 3 is a flow diagram of end-to-end application artifact set (Repository scaffold).

FIG. 4 is a diagram of machine-interpretable violation packets and derived regeneration constraint objects.

FIG. 5 is a diagram of causal association records and bounded weight updates that modify subsequent retrieval and generation.

FIG. 6 is a diagram of real-time updates and streaming telemetry feeding constraint updates.

FIG. 7 is a diagram of an example ephemeral test environment lifecycle including sandbox spin-up, deployment, execution, compliance checks, result collection, teardown, and iterative refinement loops.

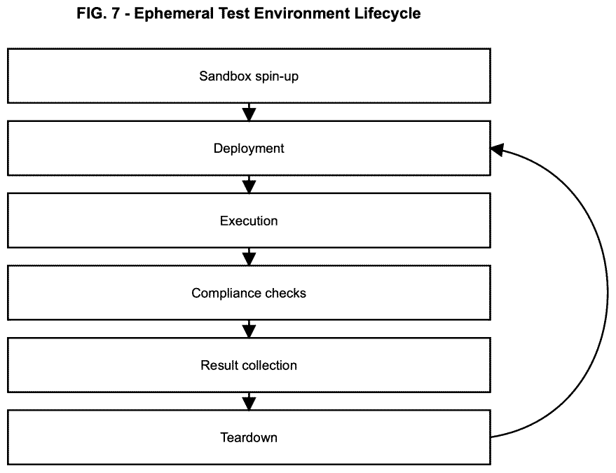

FIG. 8 is a diagram of an example deployment environment for the system, including user interaction interfaces, corpus sources for retrieval (including a vector database and a knowledge graph), and an isolated validation environment.

### DETAILED DESCRIPTION

The following description enables a person of ordinary skill in the art to make and use the disclosed embodiments. The disclosure is not limited to the described embodiments. Unless expressly required by the claims, steps may be performed in different orders, in parallel, or with intermediate steps.

### Definitions (Non-Limiting)

The following definitions are provided to improve clarity and are non-limiting unless expressly required by the claims.

“Budget constraint” includes at least one of a token budget, byte budget, character budget, time budget, compute-cost budget, memory budget, or latency budget.

“Bounded context package” includes a packaged representation of task-relevant information assembled under a budget constraint, including compressed context units and optionally a header and manifest.

“Compressed context unit” includes a structured or semi-structured representation derived from one or more context items, including summaries, extracted rules, extracted schemas, extracted API signatures, extracted code stubs, constraints, and other task-relevant units, each associated with a size estimate.

“Machine-interpretable” includes data encoded as structured fields sufficient for downstream modules to automatically evaluate and act, for example an identifier and payload, optionally with timestamps, correlation tags, evidence pointers, and confidence scores.

“Compliance violation packet” includes a machine-interpretable object that includes at least a rule identifier and an evidence pointer or evidence digest, and may also include severity, affected component identifiers, and remediation hints.

“Regeneration constraint” includes a machine-interpretable rule, parameter, pattern list, mapping, override, or weight update that modifies subsequent retrieval, compression, generation, execution, validation, or deployment behavior, including additive, subtractive, replacement, weighting, and parameter override forms.

“Programmatic execution” includes performing tasks by invoking at least one of scripts, command-line tools, SDK calls, connectors, plugins, function calls, or application programming interfaces (APIs), whether locally or via cloud services, rather than solely by simulating human UI input.

“Programmatic verification” includes verifying completion using at least one of return codes, exit codes, structured outputs, test results, logs, telemetry metrics, file diffs, object-model state, API response codes/bodies, or other machine-readable signals.

“Causal memory structure” includes any persistent structure that stores associations linking faults, violations, constraints, context units, and outcomes, including a knowledge graph, relational tables, adjacency lists, structured logs, and learned parameter tables.

“Convergence condition” includes measurable criteria indicating that an iterative loop may terminate, including satisfaction of compliance checks and at least one of functional correctness criteria or performance criteria, optionally over N consecutive cycles and/or subject to a cycle limit.

“Retrieval-augmented generation” or “RAG” includes retrieving candidate context items from one or more corpora, selecting a subset of the candidate context items by filtering and ranking, and providing the selected subset as conditioning context to at least one generative model that produces outputs based on the selected subset.

“Large language model” or “LLM” includes a generative model trained on text and configured to generate text and/or code responsive to input context. In some embodiments, an LLM operates under a context-window constraint that limits an amount of conditioning context, and budget-bounded packing is used to satisfy the context-window constraint.

“Swarm-based architecture” includes a plurality of specialized models and/or specialized model instances coordinated by an orchestration controller that assigns subtasks to specialized roles and merges outputs. In some embodiments, specialized roles include code generation, test generation, quality assurance review, security review, and compliance review. In some embodiments, specialized models are separate networks, and in other embodiments, specialized models are instances of a shared base model operating under different prompts, policies, tools, or constraints.

“Contextual memory” includes persistent or semi-persistent memory that stores conversation-derived records and/or task-derived records and that is addressable during subsequent retrieval or generation. In some embodiments, contextual memory stores entity records, relationship edges, and event records extracted from conversations and associates such records with artifacts, constraints, outcomes, and evidence.

As used herein, an ephemeral test environment is an example of an isolated validation environment. “Ephemeral test environment” includes a provisioned isolated execution environment created for validation of generated or modified artifacts and subsequently destroyed or reset. Ephemeral test environments include containers, micro-virtual machines, sandboxes, emulators, device farms, and staging environments.

“User profile” includes stored information associated with a user, group, or organization, including at least one of user preferences, domain preferences, permissions, interaction history, or organizational policy settings, used to personalize retrieval and generation.

“Extractive summarization” includes selecting or extracting portions of source content, such as sentences or spans, to form a shorter representation.

“Abstractive summarization” includes generating a shorter representation that paraphrases source content while preserving task-relevant constraints.

“Compliance agent” includes a specialized model, module, or rules engine configured to evaluate code and/or outputs against domain regulations or policies and to output compliance findings usable for remediation.

### System Overview

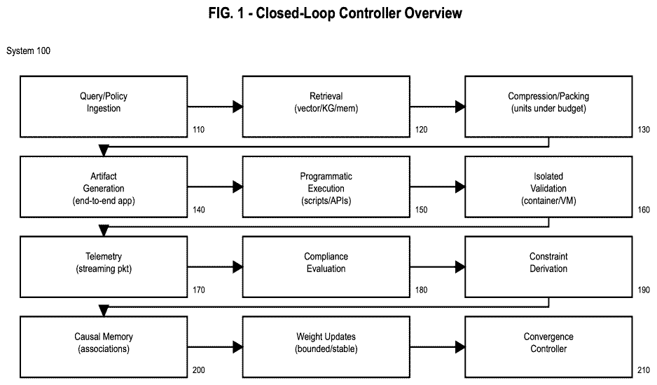

FIG. 1 illustrates a system 100 comprising: (a) a query and policy ingestion module 110, (b) a retrieval module 120, (c) a compression and packing module 130, (d) an artifact generation module 140, (e) a programmatic execution module 150, (f) an isolated validation module 160, (g) a telemetry normalization module 170, (h) a compliance evaluation module 180, (i) a constraint derivation module 190, (j) a causal memory module 200, and (k) a convergence controller 210.

The system 100 may be deployed locally, in the cloud, or in a hybrid configuration. In some embodiments, retrieval and generation run in a cloud environment while isolated validation runs in a separate controlled environment. In some embodiments, certain components run on-device and others run remotely.

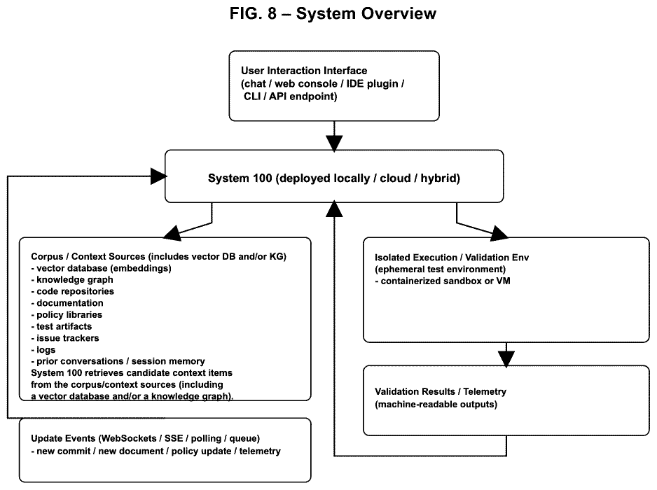

FIG. 8 illustrates an example deployment environment for system 100. In some embodiments, system 100 may be deployed locally, in the cloud, or in a hybrid configuration. In some embodiments, retrieval and generation run in a cloud environment while isolated validation runs in a separate controlled environment. In some embodiments, certain components run on-device and others run remotely.

As illustrated in FIG. 8, a user interaction interface may be implemented as a chat interface, web console, integrated development environment (IDE) plugin, command-line interface, or application programming interface endpoint, and is configured to receive user queries and user feedback.

FIG. 8 further depicts that the retrieval module retrieves candidate context items from a corpus that may include code repositories, documentation, policy libraries, test artifacts, issue trackers, logs, prior conversations, and session memory. In some embodiments, the corpus includes a vector database and/or a knowledge graph. System 100 retrieves candidate context items from the corpus/context sources (including a vector database and/or a knowledge graph).

FIG. 8 further still depicts an isolated execution environment for validation. In some embodiments, an ephemeral test environment module launches a containerized sandbox or a virtual-machine-based sandbox to autonomously validate generated code, including functional tests, security checks, and embedded domain-specific compliance checks.

FIG. 8 yet further depicts that the system may receive update events via WebSockets, server-sent events (SSE), polling, or message-queue subscriptions, and may trigger refetch->rerank->repack of a bounded context package upon update events such as new commits, new documents, updated policies, or new telemetry.

### Input Query, Multi-Modal Inputs, and Policy Gates

The system receives an input query comprising task requirements and optional constraints. In some embodiments, the input query is derived from multi-modal inputs including at least one of text, voice, images, or structured forms. In some embodiments, voice inputs are converted to text before downstream processing.

In some embodiments, the system applies policy gates that restrict actions, connectors, tool calls, or data sources based on an authorization policy, a tenant policy, a confidentiality policy, or a compliance regime.

User interaction and feedback (example). In some embodiments, the system provides a user interaction interface implemented as a chat interface, web console, integrated development environment (IDE) plugin, command-line interface, or application programming interface endpoint. The user interaction interface receives user queries and receives user feedback signals including at least one of approvals, rejections, ratings, edits, corrective annotations, or preference selections. In some embodiments, user feedback signals are converted into reward signals and/or heuristic updates used to update retrieval ranking parameters, packing priorities, and/or generation parameters, subject to stability policies.

### Multi-Stage Retrieval and Bounded Context Assembly

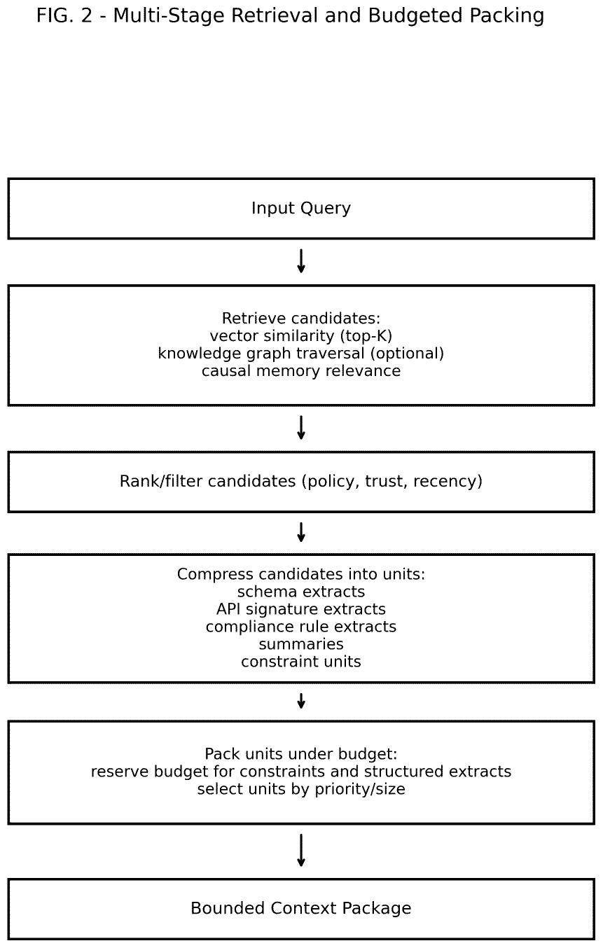

The retrieval module 120 retrieves candidate context items from a corpus that may include: code repositories, documentation, policy libraries, test artifacts, issue trackers, logs, prior conversations, and session memory (See, e.g., process diagram of multi-stage retrieval, compression into units, and packing under a budget with reserved constraint units of FIG. 2). In some embodiments, the corpus includes a vector database and/or a knowledge graph.

Embedding retrieval (example). In some embodiments, the retrieval module computes an embedding of the input query and retrieves top-K items from a vector database by similarity.

Knowledge graph retrieval (example). In some embodiments, the system traverses a knowledge graph seeded by entities derived from the query, including files, modules, APIs, policies, or prior fault signatures.

Candidate ranking (example). In some embodiments, candidates are ranked by a weighted combination of similarity, recency, trust, policy score, and causal-memory relevance.

Coarse retrieval and fine filtering (example). In some embodiments, retrieval comprises a coarse retrieval stage that retrieves a candidate set (for example, top-K items by embedding similarity) and a fine filtering stage that removes or downranks candidates based on at least one of policy rules, trust scores, recency, provenance, or causal-memory relevance. In some embodiments, a ranking stage orders the remaining candidates using a weighted scoring function and selects a subset for packing into the bounded context package.

Budgeted packing. The compression and packing module 130 compresses candidates into compressed context units and packs them into a bounded context package under a budget constraint. The budget constraint includes at least one of token, byte, time, compute-cost, memory, or latency budgets.

Reserved constraint budget. In some embodiments, the packing algorithm reserves a portion of the budget for constraint units, schema extracts, and API signature extracts, to reduce the risk of omitting critical constraints.

Context header and manifest. In some embodiments, the bounded context package includes:
(a) a header encoding task requirements, assumptions, objective metrics, and budget schema; and
(b) a manifest listing included units, excluded candidates, and optional reasons.

### Compression Into Structured Units

Compressed context units may include one or more of:
(a) summary units that summarize documents while preserving constraints;
(b) rule extract units that encode compliance rules in structured fields;
(c) schema extract units that encode data schemas, database schemas, and invariants;
(d) API signature extract units that encode API endpoints, parameters, return codes, and error contracts;
(e) code snippet units that include selected code regions below budget thresholds;
(f) constraint units derived from prior cycles.

Each compressed context unit may include: a unit_id, unit_type, payload, size_estimate, confidence score, and optional evidence references.

Keyword extraction and context-window fitting (example). In some embodiments, compression includes keyword extraction or keyphrase extraction to produce compact units that preserve salient constraints, entities, and required behaviors. In some embodiments, packing is configured to satisfy a context-window constraint of a large language model by selecting compressed units that fit within a token budget while reserving space for constraint units and structured extracts.

### End-to-End Application Artifact Generation

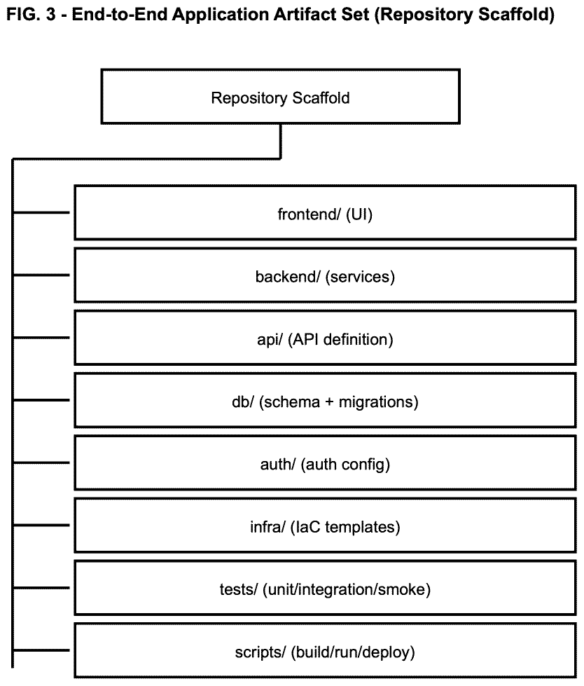

The artifact generation module 140 generates executable software artifacts based on the bounded context package (See FIG. 3). In some embodiments, the generated output comprises an end-to-end application artifact set including at least one of:
(a) a front-end user interface;
(b) one or more back-end services; (c) an API definition; (d) a database schema and/or migration artifacts; (e) authentication and authorization configuration; (f) infrastructure-as-code templates; (g) environment configuration files; (h) build scripts and test scripts; (i) unit tests, integration tests, and smoke tests; and(j) deployment artifacts for staging and/or production.

In some embodiments, the module generates a repository scaffold, module boundaries, interface contracts between modules, and verification artifacts that validate module boundaries.

LLM generation (example). In some embodiments, the artifact generation module uses at least one large language model to generate or modify code and related artifacts. In some embodiments, the bounded context package is formatted as a prompt context including a context header and a manifest, and the large language model generates artifacts conditioned on the formatted prompt context. In some embodiments, the system performs multiple large language model calls with different prompts and merges outputs to form a coherent artifact set.

Swarm-based orchestration (example). In some embodiments, the artifact generation module comprises an orchestration controller configured to coordinate a swarm-based architecture of specialized models. In some embodiments, a code generation model proposes code changes, a test-generation model proposes or updates tests, a quality assurance model reviews diffs and telemetry for regressions, and a compliance model evaluates artifacts and telemetry against compliance rules. In some embodiments, the orchestration controller routes subtasks to specialized models based on detected failures, violation packets, and constraint objects.

### Programmatic Execution (Scripts/Cli/Sdk/Connectors/Apis)

The programmatic execution module 150 executes tasks using programmatic execution. Programmatic execution includes invoking at least one of:
(a) scripts (shell scripts, Python scripts, build scripts);
(b) command-line tools (compilers, linters, test runners);
(c) SDK calls;
(d) connectors to external services (ticketing, storage, databases);
(e) plugins or extension APIs exposed by applications; and
(f) application programming interfaces (APIs), including internal APIs and external APIs.

Programmatic execution may be performed locally, on a remote host, in a cloud service, or in a managed runtime. In some embodiments, the system selects an execution target based on policy and resource constraints.

### Programmatic Verification (Return Codes, Logs, Tests, File Diffs, Object State)

The system performs programmatic verification to determine whether actions succeeded. Programmatic verification includes verifying at least one of:
(a) return codes or exit codes from scripts or tools;
(b) structured outputs (JSON/XML) and schema validation of outputs;
(c) test results from unit, integration, or smoke tests;
(d) log entries, error messages, and trace spans;
(e) telemetry metrics and performance metrics;
(f) file diffs, configuration diffs, and artifact digests;
(g) object-model state exposed by an application plugin/scripting interface; and
(h) API response codes and response bodies.

In some embodiments, verification includes comparing observed signals against expected conditions. Expected conditions may be derived from the bounded context package, policy rules, or prior cycle outcomes.

### Isolated Validation (containers, Vm, Sandbox, Emulators)

The isolated validation module 160 provisions and executes isolated environments for validation. Isolated environments include one or more of:
(a) containers;
(b) micro-virtual machines;
(c) sandboxes with restricted filesystem and network;
(d) language runtimes with restricted permissions;
(e) mobile emulators or device farms; and
(f) staging environments derived from infrastructure templates.

In some embodiments, isolated validation enforces network egress policies, resource limits, and permission boundaries. Isolation settings may be selected based on policy gates and compliance requirements.

### Telemetry Normalization and Streaming Telemetry

The telemetry module 170 collects telemetry and normalizes it into telemetry packets. Telemetry includes logs, traces, metrics, test reports, exceptions, stack traces, resource usage, and environment events.

In some embodiments, telemetry is received as a real-time stream. The system normalizes telemetry packets as the stream is received and may generate updated constraints during a running cycle or between cycles.

### Compliance Evaluation and Violation Packets

The compliance evaluation module 180 evaluates artifacts and telemetry against compliance rules and outputs machine-interpretable compliance results. Compliance rules may include privacy, security, retention, encryption, authorization, and domain-specific regulatory rules.

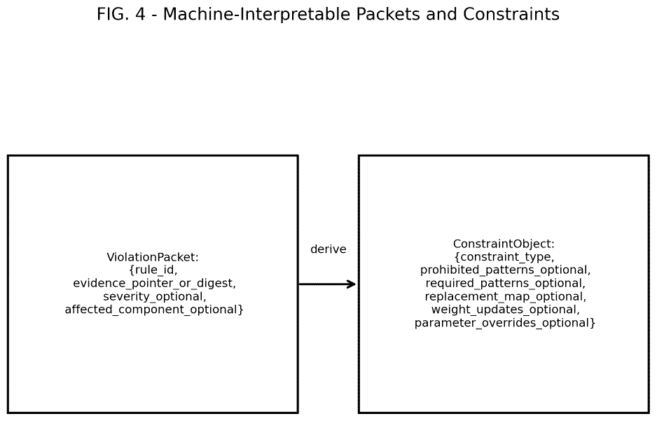

In some embodiments (See, e.g., FIG. 4—Machine-Interpretable Packets and Constraints), the system outputs one or more compliance violation packets. A compliance violation packet includes at least:
(a) rule_id; and
(b) evidence_pointer_or_digest.

In some embodiments, the packet additionally includes severity, affected_component_id, affected_artifact_id, correlation_id, and remediation hints.

### Constraint Derivation and Constraint Injection

The constraint derivation module 190 derives regeneration constraints from compliance violation packets and/or telemetry. In some embodiments, deriving regeneration constraints comprises mapping a rule_id to at least one of (also see FIG. 4—Machine-Interpretable Packets and Constraints):
(a) prohibited pattern lists;
(b) required pattern lists; (c) replacement mappings; (d) parameter overrides; and(e) retrieval weight updates.

Constraint injection. In some embodiments, derived constraints are injected into the next bounded context package as structured constraint units and/or encoded into the context header as machine-interpretable fields.

### Causal Memory and Bounded Weight Updates (Stability)

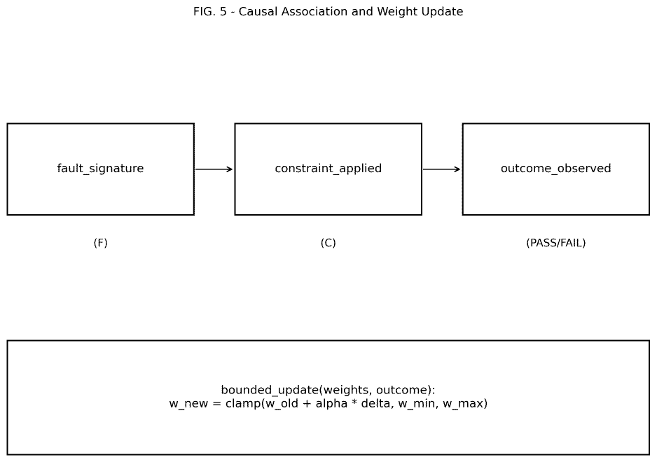

The causal memory module 200 stores associations linking faults, violation packets, constraints, context units, and outcomes (See, e.g. FIG. 5). The causal memory structure may be a knowledge graph, relational tables, structured logs, adjacency lists, or learned parameter tables.

Contextual memory across conversations (example). In some embodiments, the causal memory module is extended to store contextual memory records derived from ongoing conversations, including entity records, relationship edges, and event records. In some embodiments, the system links such records to artifact identifiers, violation packet identifiers, constraint identifiers, and outcome metrics to support subsequent retrieval seeding, reranking, and constraint selection.

In some embodiments, the system updates retrieval weights and/or generation parameters based on outcomes. Updates may be bounded by stability policies including step-size limits, clamping, and repeated-outcome requirements to reduce oscillation.

In some embodiments, retrieval weight updates are computed using reinforcement learning signals, heuristic rules, supervised scoring models, or hybrid approaches.

Feedback-driven updates (example). In some embodiments, outcomes used for bounded weight updates include at least one of user feedback signals, acceptance rates, rollback rates, manual edit rates, or user-selected severity classifications. In some embodiments, feedback-driven updates are bounded by stability policies including step-size limits, clamping, and repeated-outcome requirements.

### Convergence Controller

The convergence controller 210 iterates the closed loop until a convergence condition is satisfied or a cycle limit is reached. In some embodiments, convergence criteria include compliance_score<=threshold for N consecutive cycles and passing a test suite for N consecutive cycles.

In some embodiments, when the isolated validation module indicates a failure of at least one of a functional check, a security check, or a domain-specific compliance check, the system generates a failure record and/or a compliance violation packet identifying evidence, derives one or more regeneration constraints, regenerates or modifies at least a portion of the executable software artifacts subject to the regeneration constraints, and re-deploys the modified executable software artifacts in a refreshed isolated execution environment for re-validation. The system may repeat the cycle until the convergence condition is satisfied or a termination condition is met.

In some embodiments, if convergence is not reached, the system outputs a failure report including unresolved violations, evidence pointers, constraints attempted, and a summary of causal associations.

### Real-Time Updates (Websockets/Sse/Polling) and Auto Refetch

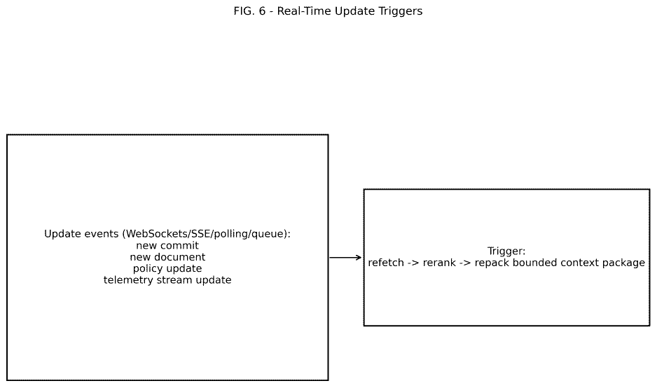

In some embodiments, the system receives update events via WebSockets, server-sent events (SSE), polling, or message-queue subscriptions (See, e.g. FIG. 6). Upon receiving an update event indicating relevant changes (new commits, new documents, new policies, new telemetry), the system performs an automatic refetch, rerank, or repack of context items.

Update-triggered regeneration (example). In some embodiments, after refetching, reranking, or repacking context responsive to an update event, the system triggers regeneration or modification of at least a portion of the executable software artifacts affected by the update event. In some embodiments, affected artifacts are identified by dependency graphs, file path matching, knowledge graph edges, or causal memory associations.

In some embodiments, a synchronization layer ingests live feeds from external sources including new code commits, updated documentation, user feedback streams, logs, and usage metrics. The ingested data may be normalized into telemetry records and/or integrated into a knowledge graph and contextual memory to enable instant refetch and consistent personalization when relevant changes occur.

### Addressing Operator and Similar Systems (Non-Limiting)

In some embodiments, the disclosed system differs from operator-type browser automation systems (including, as one example, OpenAI Operator) by emphasizing dynamic context retrieval, contextual memory, and closed-loop autonomous software creation with objective validation signals. For example, the disclosed system can retrieve and compress domain-specific context, maintain long-term memory for continuity across sessions, generate or modify executable code, deploy code in an isolated environment for testing, perform compliance checks, and adapt retrieval and generation strategies based on feedback and observed outcomes.

In some embodiments, user-interface automation is optional and may be used when programmatic interfaces are unavailable. In other embodiments, the system prefers programmatic execution and verification for repeatability and reliability, including verification via return codes, structured outputs, test results, logs, telemetry, file diffs, and object-model state.

### Implementation Schemas and Pseudocode (Non-Limiting)

The following schemas and pseudocode are provided as non-limiting enablement examples. Equivalent data structures, field names, encodings, and ordering may be used. The disclosed embodiments are not limited to the examples.

### A. Telemetrypacket Schema (Example)

TelemetryPacket = {
packet_id: string,
correlation_id: string,cycle_id: int,env_instance_id: string,packet_type: string, # LOG,
TRACE, METRIC, EXCEPTION, TEST_REPORT, DIFF, API_RESPtimestamp_ms:
int64,source_id: string, # module/service/host identifierseverity_optional: string, # INFO,
WARN, ERRORpayload_ref_or_inline: string, # URI pointer or inline small
payloadpayload_digest_optional: string, # e.g., sha256:...schema_ref_optional: string, #
schema identifier if payload is structuredtags_optional: map, # key/value
tagsprivacy_masking_applied_optional: bool}
Example packet_type encodings:
LOG: line-oriented text or JSON logs
TRACE: span_id, parent_span_id, timing
METRIC: metric_name, value, unit, window_ms
EXCEPTION: exception_type, message, stack_frames
TEST_REPORT: suite_id, passed_count, failed_count, failure_list
DIFF: artifact_id_before, artifact_id_after, diff_ref
API_RESP: http_code, endpoint_id, response_ref

### B. Violationpacket Schema (Example)

ViolationPacket = {
violation_id: string,
correlation_id: string,cycle_id: int,rule_id: string,rule_version_optional: string,severity:
string, # LOW, MEDIUM, HIGH, CRITICALcategory_optional: string, # PRIVACY,
SECURITY, RETENTION, AUTHZ, OTHERaffected_artifact_ids_optional:
list[string],affected_component_ids_optional: list[string],evidence_pointer_or_digest:
string, # pointer URI or digest (sha256:...)evidence_packet_ids_optional:
list[string], detection_method_optional: string, # STATIC, DYNAMIC,
HYBRIDconfidence_optional: float, # 0.0-1.0remediation_hint_optional:
string, timestamp_ms: int64}

### C. Constraintobject Schema (Example)

ConstraintObject = {
constraint_id: string,correlation_id: string,cycle_id: int,derived_from_violation_ids:
list[string], constraint_type: string, # ADDITIVE, SUBTRACTIVE, REPLACEMENT,
WEIGHTING, PARAM_OVERRIDEscope: map, # targets:
artifact/module/function/config keyprohibited_patterns_optional:
list[string],required_patterns_optional: list[string],replacement_map_optional: map, #
old->new libraries, APIs, code idiomsparameter_overrides_optional: map, # timeouts,
flags, env vars, policy togglesretrieval_weight_updates_optional: map,# unit_type->delta
or source->deltavalidation_overrides_optional: map, # add tests, require scanner,
etc.priority_optional: int, # for packing/resolution orderingexpires_after_cycles_optional:
int, created_at_ms: int64}

### D. Causalassociationrecord Schema (Example)

CausalAssociationRecord = {
record_id: string,
correlation_id: string,cycle_id: int,objective_id_optional: string,fault_signature_optional:
string, # e.g., DEADLOCK_SIG_12, TEST_FAIL_Xviolation_ids_optional:
list[string],constraint_ids_optional: list[string], context_unit_ids_optional:
list[string],execution_actions_optional: list[string],# tool calls, scripts, endpointsoutcome:
map, # pass/fail, compliance_score, tests_passed, metricsevidence_refs_optional:
list[string], timestamp_ms: int64}
Example outcome map fields:
outcome = {
“compliance_pass”: true/false,
“compliance_score”: float,
“tests_pass”: true/false,
“runtime_error_count”: int,
“latency_p95_ms”: int,
“cost_units”: float
}

### E. Packing Algorithm Pseudocode (Reserved Budget+Priority/Size Scoring)

Inputs:
candidate_units: list of CompressedContextUnit
budget_limit: int
reserve_policy: map (reserved sizes for constraint/schema/api_signature categories)
required_categories: list[string] (optional)
priority_weights: map (unit_type->weight, source->weight)
Outputs:
selected_units: list of CompressedContextUnit
manifest: list of include/exclude reasons
Pseudocode (illustrative):
function pack_units_under_budget(candidate_units, budget_limit, reserve_policy,
required_categories, priority_weights):
remaining = budget_limitselected = [ ]manifest = [ ]
Step 1: reserve budget for high-value categories
reserved = { }
total_reserved = 0
for cat in reserve_policy:
reserved[cat] = reserve_policy[cat]
total_reserved += reserved[cat]
if total_reserved > budget_limit:
# shrink reservations proportionally
scale = budget_limit / total_reserved
for cat in reserved:
reserved[cat] = floor(reserved[cat] * scale)
total_reserved = sum(reserved.values( ))
remaining = budget_limit - total_reserved
Step 2: mandatory inclusion for required categories (best effort)
for cat in required_categories:
best = best_unit_of_type(candidate_units, cat, priority_weights)
if best is not null and best.size_estimate <= reserved.get(cat, 0):
selected.append(best)
reserved[cat] = reserved.get(cat, 0) - best.size_estimate
manifest.append({“unit_id”:best.unit_id,“action”:“include”,“reason”:“required_category”
})
else:
manifest.append({“category”:cat,“action”:“missing”,“reason”:“no_fit_or_none”})
Step 3: fill reserved buckets with top scoring units per category
for cat in reserved:
if reserved[cat] <= 0:continueunits = filter_units(candidate_units,
unit_type=cat)units_sorted = sort_by_score_over_size(units, priority_weights)for u in
units_sorted:if u in selected:continueif u.size_estimate <=
reserved[cat]:selected.append(u)reserved[cat] -=
u.size_estimatemanifest.append({“unit_id”:u.unit_id,“action”:“include”,“reason”:“reserve
d_bucket”})if reserved[cat] <= 0:break
Step 4: fill remaining budget with best score/size across all units
remaining = remaining + sum(reserved.values( ))
units_sorted = sort_by_score_over_size(candidate_units, priority_weights)
for u in units_sorted:
if u in selected:
continue
if u.size_estimate <= remaining:
selected.append(u)
remaining -= u.size_estimate
manifest.append({“unit_id”:u.unit_id,“action”:“include”,“reason”:“best_score_per_size”}
)
else:
manifest.append({“unit_id”:u.unit_id,“action”:“exclude”,“reason”:“budget_no_fit”})
return selected, manifest
Scoring helper (illustrative):
unction unit_score(u, priority_weights):
base = 1.0
base *= priority_weights.get(“unit_type:”+u.unit_type, 1.0)
base *= priority_weights.get(“source:”+u.source_id_optional, 1.0)
base *= max(0.1, u.confidence_optional if exists else 1.0)
return base
function sort_by_score_over_size(units, priority_weights):
return sort(units, key = unit_score(u, priority_weights) / max(1, u.size_estimate),
descending=true)

### F. Constraint Derivation Mapping Pseudocode (RULE_id->Constraint Forms)

Inputs:
violation_packets: list[ViolationPacket]
mapping_table: map(rule_id -> ConstraintTemplate)
telemetry_packets: list[TelemetryPacket] (optional)
Outputs:
constraints: list[ConstraintObject]
ConstraintTemplate schema (example):
ConstraintTemplate = {rule_id: string,constraint_type:
string,prohibited_patterns_optional: list[string],required_patterns_optional:
list[string],replacement_map_optional: map,parameter_overrides_optional:
map, retrieval_weight_updates_optional: map,validation_overrides_optional: map}
Pseudocode (illustrative):
function derive_constraints(violation_packets, mapping_table, telemetry_packets):
constraints = [ ]for vp in violation_packets:tmpl = mapping_table.get(vp.rule_id)if tmpl is
null:# fallback: generic constraint capturing the rule and evidencec =
new_constraint_object( )c.constraint_type = “ADDITIVE”c.required_patterns_optional =
[“SATISFY_RULE:”+vp.rule_id]c.derived_from_violation_ids =
[vp.violation_id]constraints.append(c)continue
C = new_constraint_object( )
c.constraint_type = tmpl.constraint_type
c.prohibited_patterns_optional = tmpl.prohibited_patterns_optional
c.required_patterns_optional = tmpl.required_patterns_optional
c.replacement_map_optional = tmpl.replacement_map_optional
c.parameter_overrides_optional = tmpl.parameter_overrides_optional
c.retrieval_weight_updates_optional = tmpl.retrieval_weight_updates_optional
c.validation_overrides_optional = tmpl.validation_overrides_optional
c.derived_from_violation_ids = [vp.violation_id]
# scope selection heuristic (example)
if vp.affected_artifact_ids_optional exists:
c.scope[“artifacts”] = vp.affected_artifact_ids_optional
if vp.affected_component_ids_optional exists:
c.scope[“components“] = vp.affected_component_ids_optional
constraints.append(c)
optional: merge compatible constraints to reduce churn
constraints = merge_constraints_by_scope_and_type(constraints)
return constraints

### G. Bounded Weight Update Pseudocode (Clamp, Step Size, Repeated Outcomes)

Inputs:
weights: map(key -> float)
record: CausalAssociationRecord
policy: WeightUpdatePolicy
Outputs:
new_weights
WeightUpdatePolicy schema (example):
WeightUpdatePolicy = {alpha: float, # learning ratemax_step: float, # max absolute
change per updatemin_weight: float,max_weight: float,require_repeats: int, # require N
similar outcomes before updatekey_groups_optional: map # group keys for
normalization}
Pseudocode (illustrative):
function bounded_update_weights(weights, record, policy, history):
history stores last M outcomes per key
deltas = compute_deltas_from_outcome(record.outcome)
new_weights = copy(weights)
for key in deltas:
# enforce repeated-outcome requirement
if policy.require_repeats > 1:
if not has_repeated_outcome(history, key, policy.require_repeats, record.outcome):
continue
delta = deltas[key]
step = clamp(policy.alpha * delta, -policy.max_step, policy.max_step)
w = new_weights.get(key, 0.0)
w2 = clamp(w + step, policy.min_weight, policy.max_weight)
new_weights[key] = w2
optional normalization by groups
if policy.key_groups_optional exists:
new_weights = normalize_groups(new_weights, policy.key_groups_optional)
return new_weights
function compute_deltas_from_outcome(outcome):
deltas = { }
examples:
if outcome[“compliance_pass”] == false:
deltas[“prefer_compliance_rule_extracts”] = +1.0
deltas[“prefer_long_docs”] = −0.5
if outcome[“tests_pass”] == false:
deltas[“prefer_test_units”] = +1.0
if outcome[“latency_p95_ms”] > outcome_target_latency:
deltas[“prefer_fast_tools“] = +0.5
return deltas
function clamp(x, lo, hi):
if x < lo: return lo
if x > hi: return hi
return x

### Non-Limiting Use Cases

The following use cases are illustrative and non-limiting.
Use Case A: Customer Support Chatbot. The system maintains long-term context over extended dialogues, retrieves relevant product documentation using multi-stage filtering over a vector database and a knowledge graph, adapts retrieval strategies based on user feedback or performance metrics, and integrates real-time updates when documentation or code changes are introduced.
Use Case B: Medical Diagnosis Assistant. The system retrieves patient history and relevant clinical context, maintains contextual memory across sessions, and produces context-aware assistance. The system may generate or update telehealth forms and test generated artifacts for compliance using domain-specific compliance checks, including HIPAA-related checks, in an ephemeral environment.
Use Case C: Legal Research Assistant. The system retrieves relevant statutes and case law, produces concise briefs, generates or updates automated contract templates, and validates outputs for confidentiality policy compliance.
Use Case D: Enterprise Software Creation. The system receives a high-level directive such as building an employee scheduling application with PCI compliance for credit card handling, generates front-end, back-end, and database schema artifacts, and validates artifacts in an isolated environment with compliance checks.
Use Case E: Illustrative Workflow Example. User prompt: “Create a HIPAA-compliant telehealth booking tool”. The system parses the prompt, identifies modules including scheduling, encryption, and authentication, generates prototype code, builds and tests in an ephemeral environment, checks for HIPAA compliance (including no plaintext protected health information and secure endpoints), flags encryption gaps, triggers automatic refactoring, and outputs a deployable artifact set. In some embodiments, help desk documentation is auto-generated from code meta tags or structured annotations.
Use Case 1: End-to-End App Creation From a Prompt.

A user provides a prompt specifying an application, user flows, data fields, compliance constraints, and performance goals. The system assembles a bounded context package under a budget, generates an end-to-end application artifact set including UI, backend services, database schema/migrations, auth configuration, IaC templates, tests, scripts, and deployment artifacts, validates in isolated environments, derives constraints from failures and compliance violations, iterates, and outputs a converged artifact set and a report.
Use Case 2: Tool/API-Driven Task Execution.

The system invokes a connector API to create records in a CRM, invokes a CLI tool to run tests, and invokes an SDK call to fetch a dataset. Verification uses API response codes, exit codes, logs, and file diffs. The system iterates until compliance and test criteria are satisfied.
Use Case 3: Compliance-driven Refactor.

The compliance module detects that logs contain unmasked sensitive data and outputs a violation packet with rule_id and evidence pointer. The constraint module maps rule_id to a prohibited pattern list and required masking patterns. The system regenerates affected code, re-executes tests, and stores causal associations to reduce recurrence.
Use Case 4: Budget-Constrained Retrieval Optimization.

The system repeatedly exceeds a token budget. A weighting constraint reduces inclusion of long narrative docs and increases inclusion of schema/API signature extracts. Subsequent cycles pack within budget and improve convergence.
Use Case 5: Streaming Telemetry Repair.

During runtime execution, telemetry packets stream in and indicate a concurrency deadlock signature. The system derives constraints to adjust lock ordering or timeouts, regenerates affected code, and re-validates.
Use Case 6: Multi-Session Memory.

A prior session stored that a particular violation class is best fixed by a specific constraint. In a later session, causal memory increases retrieval weight for relevant constraint units, reducing cycles to converge.
Use Case 7: Automated CI/CD Remediation.

The system generates a patch and triggers a CI pipeline using a connector API. The pipeline fails with a test report. The system parses the test report telemetry, generates a violation packet or fault signature, derives constraints to modify the patch or add missing tests, regenerates, and re-triggers CI until pipeline checks pass or a cycle limit is reached.
Use Case 8: Infrastructure-as-Code Generation and Validation.

The system generates infrastructure templates (IaC) and environment configuration files, then validates them in an isolated environment using static scanners and deployment simulators. Compliance evaluation flags a policy violation (e.g., open network rule). The system derives a replacement constraint to adjust the template, regenerates, and re-validates until compliance and functional checks pass.
Use Case 9: Data Pipeline Creation With Policy Constraints.

The system generates an ETL pipeline that reads from a source and writes to a destination with masking rules. Validation includes unit tests and sample-run telemetry. A compliance violation packet indicates sensitive fields were not masked. The system injects required masking patterns as constraints, regenerates, and re-tests.
Use Case 10: Enterprise Connector Workflows.

The system uses connectors to interact with enterprise applications (CRM, ticketing, storage). Tasks are executed via APIs and verified via response codes, object-model state, and logs. If a permission error occurs, the system derives constraints requiring additional auth scopes or a different connector path and retries under policy gates.
Use Case 11: Document/Spreadsheet Automation via Programmatic Interfaces.

The system generates scripts and tool calls to create or modify documents/spreadsheets, then verifies success by comparing output file diffs and checking object-model state (e.g., a worksheet exists and contains expected columns). Failures generate fault signatures that drive regeneration constraints.
Use Case 12: Mobile App Creation and Emulator Validation.

The system generates a mobile app artifact set, runs it on an emulator or device farm, collects logs and UI test results as telemetry, evaluates compliance rules, derives constraints from violations (e.g., missing permission rationale screens), regenerates, and re-tests until convergence.
Use Case 13: Security Hardening Loop.

The system generates code and configuration, runs security scanners in an isolated environment, and produces violation packets for high-severity findings. Constraints require removing vulnerable dependencies, adding secure defaults, and tightening egress policies. The loop regenerates and re-scans until findings are below thresholds.
Use Case 14: Cost/Latency Budget Optimization.

The system enforces a compute-cost or latency budget for retrieval and validation cycles. When cost budgets are exceeded, the system issues a budget fault signature and derives weighting constraints that favor structured extracts over long documents and reduce expensive validation steps, while preserving compliance checks.

### Competitor Workarounds and Variations (Non-Limiting)

This section provides non-limiting examples of competitor workaround attempts and counter-embodiments supported by this disclosure. The purpose is to preserve scope across foreseeable substitutions and to support later continuations and enforcement strategies.
Workaround attempt 1:“We do not use a vector database.”

Counter-embodiment: Retrieval may be performed by any combination of vector retrieval, lexical retrieval, rules-based retrieval, deterministic indexing, knowledge graph traversal, or causal memory relevance, while still enforcing bounded context assembly under a budget constraint.
Workaround attempt 2:“We do not use a knowledge graph.”

Counter-embodiment: The causal memory structure may be implemented as relational tables, adjacency lists, structured logs, or learned parameter tables, and may still update retrieval and generation parameters based on stored associations linking faults, violations, constraints, and outcomes.
Workaround attempt 3:“We do not compress; we use larger models.”

Counter-embodiment: Budgets may be defined in tokens, bytes, time, compute cost, memory, or latency, and compression and packing remain useful for determinism, cost control, policy enforcement, and constraint retention even when larger contexts are available.
Workaround attempt 4:“We do not have machine-interpretable packets; we only output text.”

Counter-embodiment: Machine-interpretable packets may be encoded as typed records, structured logs, JSON-like objects, or database rows. Systems may also include an explanatory text portion in addition to structured fields.
Workaround attempt 5:“We do not derive constraints; we just try again.”

Counter-embodiment: Constraint derivation may be explicit (constraint objects) or implicit (weight updates, parameter overrides, policy injections). Prompt modifications that introduce or remove required behaviors based on violations are a form of constraint injection.
Workaround attempt 6:“We do not execute in isolation; we only do static checks.” Counter-embodiment: Validation may be static-only, dynamic-only, or hybrid. The disclosed closed-loop controller supports multiple validation modes and can converge using whichever validation signals are available.
Workaround attempt 7:“We do not use programmatic execution; we use UI automation.”

Counter-embodiment: Programmatic execution is one embodiment. Related applications may claim UI-driven agents. In this disclosure, programmatic execution includes scripts, CLI tools, SDK calls, connectors, plugins, and APIs, locally and/or in the cloud.
Workaround attempt 8:“We do not use return codes or file diffs; we use only tests.”

Counter-embodiment: Programmatic verification includes any combination of return codes, exit codes, logs, tests, telemetry metrics, file diffs, object-model state, and API responses. No single verification modality is required unless expressly claimed.
Workaround attempt 9:“We do not update weights; we are stateless.”

Counter-embodiment: The causal memory structure may be optional in some embodiments, but when present it provides performance improvements by biasing retrieval and generation based on prior outcomes. Continuations may claim memoryless and memoryful variants separately.
Workaround attempt 10:“We do not converge; we do one pass.”

Counter-embodiment: The controller may perform a single cycle or multiple cycles. A one-pass configuration is an embodiment. Multi-cycle convergence is an embodiment.

### Disclaimers and Claim Interpretation

The headings used herein are for convenience only and do not limit the scope of the disclosure or the claims.

Unless otherwise indicated, the terms “including,” “includes,” “comprising,” and “comprises” are used in an open-ended sense.

The term “or” is inclusive unless the context clearly indicates otherwise. The terms “a” and “an” generally mean “one or more” unless the context clearly indicates otherwise.

Examples, numerical values, thresholds, counts, timing values, and implementation details are illustrative and non-limiting.

Steps may be performed in different orders, in parallel, or with intermediate steps unless expressly required by the claims.

Module names are exemplary. Equivalent partitions, consolidations, or distributed implementations may be used.

Data structures and packet formats are exemplary. Equivalent encodings may be used, including typed messages, JSON-like objects, database rows, or structured logs.

“Programmatic execution” includes scripts, CLI tools, SDK calls, connectors, plugins, function calls, and application APIs, whether local or cloud-based.

“Programmatic verification” includes return codes, exit codes, logs, tests, telemetry, file diffs, object-model state, and API responses.

Nothing herein is intended to limit the claims to the specific embodiments described. The scope of the invention is defined by the claims and equivalents thereof as permitted by law.

1. A computer-implemented system comprising:
(a) a user interaction interface configured to receive a user query and to receive user feedback during an interaction session;
(b) a retrieval-augmented generation module configured to retrieve candidate context items based on the user query from (i) a vector database storing embeddings of content items and (ii) a knowledge graph storing entities and relationships;
(c) a contextual memory mechanism configured to store and update contextual memory data representing at least entities, relationships, events, and user-specific context across conversations;
(d) an adaptive retrieval subsystem configured to adjust at least one of retrieval weights or retrieval strategies based on at least one of reinforcement learning signals, heuristic feedback, user feedback, or performance metrics;
(e) a swarm-based architecture comprising a plurality of specialized artificial intelligence models including at least one model configured to generate or modify executable software code using at least the candidate context items and the contextual memory data;
(f) an ephemeral test environment module configured to automatically deploy the executable software code into an isolated environment and to perform at least one of functional checks, security checks, or domain-specific compliance checks; and
(g) a real-time update mechanism configured to synchronize newly acquired or updated data via a communication protocol and, responsive to at least one update event, trigger a refetch of context and regeneration or modification of at least a portion of the executable software code.

2. The system of claim 1, wherein the retrieval-augmented generation module performs multi-stage filtering comprising coarse retrieval, fine-grained filtering, and ranking to select a subset of context for use by at least one of the specialized artificial intelligence models.

3. The system of claim 1, wherein the system is configured to derive structured requirements from the user query, the structured requirements including at least one of user stories, a data schema, or compliance rules, and wherein generating or modifying the executable software code is performed based on the structured requirements.

4. The system of claim 1, further comprising a compression module configured to compress retrieved context via at least one of extractive summarization, abstractive summarization, or keyword extraction prior to providing the retrieved context to at least one of the specialized artificial intelligence models.

5. The system of claim 4, wherein the compression module is configured to reduce context to fit within a context-window constraint of a large language model.

6. The system of claim 1, wherein the swarm-based architecture comprises at least one summarizer agent, at least one code generation agent, at least one quality assurance agent, and at least one compliance agent.

7. The system of claim 1, wherein, responsive to a failure of at least one of the functional checks, the security checks, or the domain-specific compliance checks, the system triggers regeneration or modification of at least a portion of the executable software code and re-deploys the modified executable software code in a refreshed ephemeral test environment for re-validation.

8. The system of claim 1, wherein the ephemeral test environment module performs functional checks on the executable software code.

9. The system of claim 1, wherein the ephemeral test environment module performs security checks on the executable software code.

10. The system of claim 1, wherein the domain-specific compliance checks include compliance checks for at least one of HIPAA, PCI, or GDPR.

11. The system of claim 1, wherein the system is configured to iteratively refine the executable software code based on results produced by the ephemeral test environment module until a stability condition and a compliance condition are satisfied.

12. The system of claim 1, wherein the real-time update mechanism synchronizes newly acquired or updated data using WebSockets, server-sent events, or polling.

13. The system of claim 1, wherein the real-time update mechanism is configured, responsive to detecting updated data comprising at least one of new code commits or updated domain data, to trigger a refetch of context and to trigger regeneration or modification of at least a portion of the executable software code based on the refetched context.

14. The system of claim 1, wherein the contextual memory mechanism maintains the contextual memory data in a graph-based data structure that links at least entities and relationships over multiple sessions.

15. The system of claim 1, wherein the system generates personalized responses and code modifications based on at least one of a user profile, the contextual memory mechanism, or compressed context units.

16. A computer-implemented method for dynamic context retrieval and autonomous software generation, the method comprising:
retrieving relevant context using coarse retrieval and fine-grained filtering from a vector database;
compressing the context via summarization or keyword extraction;
generating context-aware responses using a large language model connected to a contextual memory system;
automatically generating or modifying executable software code based on the retrieved, compressed context;
deploying the generated code in an ephemeral test environment for functional checks, security checks, and compliance checks;
continuously updating the contextual memory with new data from ongoing conversations; and
refining retrieval and generation strategies based on user feedback or performance metrics.

17. The method of claim 16, further comprising retrieving additional context from a knowledge graph that stores entities and relationships associated with at least one of task requirements or the contextual memory system.

18. The method of claim 16, further comprising deriving structured requirements from the user query, the structured requirements including at least one of user stories, a data schema, or compliance rules, prior to automatically generating or modifying the executable software code.

19. The method of claim 16, wherein deploying the executable software code in the ephemeral test environment comprises, responsive to a failure of at least one of the functional checks, the security checks, or the compliance checks, regenerating or modifying at least a portion of the executable software code and re-deploying the modified executable software code in a refreshed ephemeral test environment for re-validation.

20. The method of claim 16, wherein automatically generating or modifying executable software code is performed by a swarm-based architecture of specialized artificial intelligence models including at least one code generation agent and at least one compliance agent.

21. A computer-implemented system executed by one or more processors and configured to generate and iteratively improve executable software artifacts under a budget constraint, the system comprising:
(a) a context assembly module configured to assemble a bounded context package under the budget constraint by compressing candidate context items into compressed context units and packing the compressed context units into the bounded context package;
(b) a reserved-budget module configured to reserve, within the budget constraint, a reserved constraint budget for constraint units;
(c) a context header generator configured to generate a context header for the bounded context package, the context header encoding machine-interpretable fields;
(d) an artifact generation module configured to generate one or more executable software artifacts using the bounded context package;
(e) an isolated validation module configured to validate at least a portion of the executable software artifacts in an isolated execution environment and to produce validation telemetry;
(f) a telemetry normalization module configured to normalize the validation telemetry into TelemetryPacket records;
(g) a compliance evaluation module configured to evaluate at least a portion of the executable software artifacts against compliance rules and to output ViolationPacket records including at least a rule_id and an evidence_pointer_or_digest;
(h) a constraint derivation module configured to derive one or more regeneration ConstraintObject records based on the ViolationPacket records, the ConstraintObject records comprising at least one of prohibited patterns, required patterns, replacement mappings, parameter overrides, or retrieval weight updates;
(i) a constraint injection module configured to inject at least one derived ConstraintObject record into a subsequent bounded context package as a constraint unit or as a machine-interpretable field encoded in a subsequent context header; and
(j) a convergence controller configured to iteratively cause regeneration and re-validation of at least a portion of the executable software artifacts until a convergence condition is satisfied or a termination condition is reached.

22. The system of claim 21, wherein the budget constraint comprises at least one of a token budget, a byte budget, a character budget, a time budget, a compute-cost budget, a memory budget, or a latency budget.

23. The system of claim 21, wherein the context header encodes at least task requirements, assumptions, objective metrics, and a budget schema.

24. The system of claim 21, wherein the bounded context package further comprises a manifest that lists included units, excluded candidate context items, and exclusion reasons for at least one excluded candidate context item.

25. The system of claim 21, wherein each TelemetryPacket record includes at least a packet_id, a correlation_id, a cycle_id, a packet_type, and a timestamp field, and optionally includes a payload reference field or a payload digest field.

26. A computer-implemented method executed by one or more processors and configured to generate and iteratively improve executable software artifacts under a budget constraint, the method comprising:
receiving an input query comprising task requirements; assembling a bounded context package under the budget constraint by compressing candidate context items into compressed context units and packing the compressed context units into the bounded context package; reserving, within the budget constraint, a reserved constraint budget for constraint units; generating a context header encoding machine-interpretable fields; executing an artifact generation module to generate one or more executable software artifacts using the bounded context package; validating at least a portion of the executable software artifacts in an isolated execution environment to produce validation telemetry; normalizing the validation telemetry into TelemetryPacket records; evaluating compliance rules to output ViolationPacket records including at least rule_id and evidence_pointer_or_digest; deriving one or more regeneration ConstraintObject records based on the ViolationPacket records; injecting at least one derived ConstraintObject record into a subsequent bounded context package as a constraint unit or as a machine-interpretable field encoded in a subsequent context header; and iteratively regenerating and re-validating at least a portion of the executable software artifacts until a convergence condition is satisfied or a termination condition is reached.

27. The method of claim 26, further comprising executing tasks using programmatic execution comprising invoking at least one of scripts, command-line tools, SDK calls, connectors to external services, plugins or extension APIs exposed by applications, or application programming interfaces, and wherein validating includes programmatic verification based on at least one of return codes, exit codes, structured outputs with schema validation, test results, logs, telemetry metrics, file diffs, configuration diffs, or object-model state.

28. The method of claim 26, wherein the evidence_pointer_or_digest includes at least one of a pointer identifying an evidence location or a digest having a prefix indicating a hash scheme.

29. The method of claim 26, further comprising updating retrieval weights or generation parameters based on outcomes of at least one cycle, wherein the updating is bounded by stability policies including step-size limits, clamping, or repeated-outcome requirements.

30. The method of claim 26, further comprising receiving update events via at least one of WebSockets, server-sent events, polling, or message-queue subscriptions and, responsive to an update event indicating new commits, new documents, updated policies, or new telemetry, performing an automatic refetch, rerank, or repack of context used to assemble the bounded context package.
